(19) United States
(12) Patent Application Publication
(10) Pub. No.: US 2026/0364841 A1
(43) Pub. Date: Nov. 19, 2026

(54) BREAD SLICER

(71) Applicant: Bizerba SE & Co. KG, Balingen (DE)

(72) Inventors: Leo KORELL, Balingen-Frommern (DE); Marius OBERLE, Bisingen-Wessingen (DE)

(21) Appl. No.: 19/676,858

(22) Filed: May 14, 2026

(30) Foreign Application Priority Data
May 18, 2025 (EP) 25177152.3

(51) Int. Cl. B26D 3/28; B26D 7/06

(52) U.S. Cl. CPC B26D 3/28; B26D 7/0641; B26D 2210/06

(57) ABSTRACT

A slicer includes a housing, a chute, a bread flap, a cover, and a lever mechanism. The housing encloses a drive motor and a circular knife. The chute has first and second chute regions, which are separated by a knife gap. The bread flap is part of/forms the first chute region. The bread flap continues the second chute region in the longitudinal direction in a working position. The bread flap tilts about an axis of rotation in a removal position in comparison with the working position. The cover opens up access to the chute in an open state and covers the chute in a closed state. The lever mechanism moves the bread flap from the removal position into the working position when the cover is moved from the open state into the closed state. There is no mechanical connection between the cover and the lever mechanism in the open state.

### CROSS REFERENCE TO RELATED APPLICATIONS

This application claims benefit to European Patent Application No. 25177152.3, filed on May 18, 2025, which is hereby incorporated by reference herein.

### FIELD

The present disclosure relates to a slicer for cutting off slices of material to be sliced, including bread.

### BACKGROUND

WO2021/259407A1 discloses a bread slicer with a chute for the material to be sliced, which is separated by a knife gap. The machine comprises a gripping device which is movable in the longitudinal direction of the chute for the material to be sliced, and the bread is moved along the chute for the material to be sliced over the knife gap and is sliced by the knife here.

### SUMMARY

In an embodiment, the present disclosure provides a slicer that cuts off slices of material to be sliced. The slicer includes a machine housing, a chute, a tiltable bread flap, a cover, and a lever mechanism. The machine housing encloses a drive motor and a circular knife. The circular knife is supported by a knife arm and is rotatably fastened to the knife arm. A chute for the material to be sliced is configured to receive the material to be sliced. The material to be sliced is movable in a longitudinal direction of the chute for the material to be sliced by a feed plate. The chute for the material to be sliced has a first chute region and a second chute region. The first chute region of the chute for the material to be sliced and the second chute region of the chute for the material to be sliced are at least partially separated by a knife gap. The tiltable bread flap is part of the first chute region or forms the first chute region. The tiltable bread flap continues the second chute region in the longitudinal direction in a working position. The bread flap is tiltable about an axis of rotation in a removal position in comparison with the working position. The cover at least partially opens up access to the chute for the material to be sliced in an open state and covers the chute for the material to be sliced in a closed state. The lever mechanism moves the tiltable bread flap from the removal position into the working position. The lever mechanism transfers the tiltable bread flap from the removal position into the working position when the cover is moved from the open state into the closed state. There is no mechanical connection between the cover and the lever mechanism in the open state.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a slicer according to the present disclosure;

FIG. 2 shows the slicing chute of a slicer according to the present disclosure;

FIG. 3 shows the slicer according to the present disclosure with an open cover;

FIG. 4 shows the slicer according to the present disclosure with a partially open cover;

FIG. 5 shows the slicer according to the present disclosure with a closed cover;

FIG. 6 shows the lever mechanism of the slicer according to the present disclosure when the bread flap is in the removal position;

FIG. 7 shows the lever mechanism of the slicer according to the present disclosure when the bread flap is located in the working position;

FIG. 8 shows the joint of the lever mechanism of the slicer according to the present disclosure when the bread flap is located in the removal position;

FIG. 9 shows a first view of the guide element of the lever mechanism of the slicer according to the present disclosure;

FIG. 10 shows a second view of the guide element of the lever mechanism of the slicer according to the present disclosure;

FIG. 11 shows a view from above of the chute for the material to be sliced of the slicer according to the present disclosure;

FIG. 12 shows a view from the front of the chute for the material to be sliced of the slicer according to the present disclosure;

FIG. 13 shows the effect of the rotation of the longitudinal direction of the chute for the material to be sliced on the maximum bread length and the time during which the knife does not engage into the knife slot;

FIG. 14 shows a view of the feed unit of the slicer according to the present disclosure;

FIG. 15 shows the feed unit of the slicer according to the present disclosure in the starting position in the closed state of the gripper;

FIG. 16 shows the feed unit of the slicer according to the present disclosure in the starting position in the open state of the gripper;

FIG. 17 shows the feed unit of the slicer according to the present disclosure outside the coupling;

FIG. 18 shows a first view of the bread flap and of the slice support of the slicer according to the present disclosure, wherein the bread flap is located in the working position;

FIG. 19 shows a second view of the bread flap and the slice support of the slicer according to the present disclosure, wherein the bread flap is located in the working position;

FIG. 20 shows a third view of the bread flap and the slice support of the slicer according to the present disclosure, wherein the bread flap is located in the working position;

FIG. 21 shows a second view of the bread flap and the slice support of the slicer according to the present disclosure, wherein the bread flap is located between the working position and the removal position; and

FIG. 22 shows a third view of the bread flap and the slice support of the slicer according to the present disclosure, wherein the bread flap is located between the working position and the removal position.

### DETAILED DESCRIPTION

Aspects of the present disclosure provide an improved slicer.

According to the present disclosure, a slicer for cutting off slices of material to be sliced, in particular bread, is proposed. The slicer has a machine housing. The machine housing encloses a drive motor and a circular knife. The circular knife is carried by a knife arm and is rotatably fastened to the knife arm. The slicer comprises a chute for the material to be sliced for receiving the material to be sliced. The material to be sliced can be moved in the chute for the material to be sliced by means of a feed plate in the longitudinal direction of the chute for the material to be sliced. The chute for the material to be sliced comprises a first chute region and a second chute region. The first chute region of the chute for the material to be sliced and the second chute region of the chute for the material to be sliced are at least partially separated by a knife gap.

The first chute region comprises a tiltable bread flap which is part of the first chute region or forms the first chute region. In a working position, the tiltable bread flap continues the second chute region in the longitudinal direction. In a removal position, the bread flap is tilted about an axis of rotation in comparison with the working position. The slicer comprises a cover which at least partially opens up the access to the chute for the material to be sliced in the open state and covers the chute for the material to be sliced in the closed state. The slicer comprises a lever mechanism for moving the tiltable bread flap from the removal position into the working position. When the cover is moved from the open state into the closed state, the lever mechanism transfers the tiltable bread flap from the removal position into the working position, wherein there is no mechanical connection between the cover and the lever mechanism in the open state.

In one aspect, the tiltable bread flap is tilted in the direction of the cover in the removal position in comparison with the working position. In one aspect, the cover is attached to the top of the machine housing. In one aspect, the cover is displaceable. In one aspect, the cover can be displaced on rails, in particular in each case one rail being located on the left and on the right side of the bread chute, wherein the rails run parallel to the lateral wall of the machine housing. In one aspect, the cover covers slightly more than half of the cross section of the machine housing and, in a closed state, is located on the rail track in the front region of the cross section of the machine housing and, in an open state, is located in the rear region of the cross section of the machine housing. The cross section of the machine housing is understood to mean the projection of the machine housing onto the ground, on which the slicer stands. In one aspect, the rear region of the cross section of the machine housing is covered by a further cover, in particular by a non-displaceable further cover. In one embodiment, both the cover and the further cover cover somewhat more than half of the machine housing and overlap in the closed state. In one aspect, the cover is displaceable above the further cover. In one aspect, the chute for the material to be sliced is located within the machine housing. In one aspect, the machine housing comprises at least one installation space which is accessible for service purposes, in which the knife motor and the knife drive as well as controllers and electrical circuits are located.

The advantage for the operator is that, during cleaning or when reaching into the chute region of the slicer, by pressing the tiltable bread flap downward, the cover is not at the same time pulled closed by means of a fixed coupling between the bread flap and the cover. As a result, there would be a considerable risk of injury. A careless operator could press heavily and/or quickly on the tiltable bread flap during cleaning. They would have their hand and partly their arm in the region of the chute for the material to be sliced. As a result of the movement of the bread flap, a coupling between the bread flap and the cover would lead to a movement of the cover in the direction of the closed state. The operator would pinch their arm between the machine housing and the cover. In the best case, this represents an unpleasant experience for the operator, in the worst case a considerable risk of injury. This can only be countered with the aid of a locking means or a complicated coupling mechanism which prevents this. However, the aspect according to the present disclosure allows the operator to move the bread flap freely for cleaning purposes without this having any effect on the position of the cover. Thus, the operator is enabled to sufficiently clean the interior of the slicer, in particular the chute for the material to be sliced. In particular, if the tiltable bread flap is at the same time used as a packaging aid which is gripped, touched and moved by the operator during packaging in a certain form during each bread slicing operation, it is of considerable advantage if the bread flap and the cover are mechanically decoupled.

In one aspect, the lever mechanism comprises a spring which permanently exerts a spring force. The spring force presses the tiltable bread flap in the direction of the removal position.

In one aspect, the axis of rotation is a shaft, to which the tiltable bread flap is rigidly fastened.

In one aspect, the lever mechanism comprises a lever which extends in the machine housing from the axis of rotation toward the cover. That end of the lever which is remote from the axis of rotation is designed as a contact element or comprises a contact element. The cover comprises a pressure element which is provided to make contact with the contact element of the lever mechanism and actuate the lever when the cover is moved from the open state into the closed state. In this context, the actuation of the lever is to be understood as meaning that the lever is touched on the contact element by the pressure element and is set into a movement, such that the lever moves in its intended movement direction.

In one aspect, the lever is located in a first lever position, in which the tiltable bread flap is located in the removal position. The lever is located in a second lever position, in which the tiltable bread flap is located in the working position. The lever is movable between the first lever position and the second lever position.

In one aspect, the lever can be located in the first lever position. If the cover is then completely open, that is to say the cover is located in its open state, in particular in its open end state, there is no mechanical connection between the pressure element of the cover and the contact element of the lever.

In one aspect, there is a third lever position between the first lever position and the second lever position. When moving the cover from the open state to the closed state, the pressure element of the cover makes contact with the contact element of the lever when the lever is located in the first lever position. The lever can be moved by the pressure element of the cover as far as into the third lever position. This movement of the lever is made by a movement of the cover by an operator from the open state toward the closed state. The cover is in the closed state when the lever is located in the third lever position. The pressure element of the cover and the contact element of the lever make contact with each other when this lever position is reached. In other words, when the cover is closed from the open state to the closed state, the lever is moved by the pressure element of the cover from the first lever position as far as the third lever position. In the third lever position, the tiltable bread flap has not yet reached the working position. There is a spring mechanism which presses the lever from the third lever position into the second lever position. Thus, after the cover has been closed, the lever is pressed by the spring mechanism from the third lever position into the second lever position. The tiltable bread flap is then located in the working position. A mechanical connection or contact between the pressure element of the cover and the contact element of the lever mechanism then no longer exists.

The technical effect to be explicitly emphasized which applies to all aspects is that the lever can be moved not only with the aid of the pressure element, but rather can also be moved in other ways. For example, the spring can also move the lever with its spring force. The lever can also be moved manually, for example. If the cover is open, an operator can reach into the chute for the material to be sliced. For example, they can move the lever counter to the spring force, such that the tiltable bread flap moves from the removal position in the direction of the working position. This can be useful, for example, in cleaning operations. They can likewise press on the tiltable bread flap and move it from the removal position in the direction of the working position. When cleaning the bread flap, this can also happen unintentionally, for example, if the bread flap is cleaned with a cleaning cloth with a high contact pressure. The bread flap then moves counter to the spring force from the removal position in the direction of the working position, since the bread flap is not separately locked during cleaning or when the cover is in the open state. If the operator manually moves the bread flap, intentionally or unintentionally, from the removal position in the direction of the working position, the lever likewise moves from its first lever position in the direction of the second lever position. In the aspect which provides a third lever position, the lever thus also moves into the third lever position. In the aspect in which there is a spring mechanism which presses the lever from the third lever position into the second lever position, the operator can, for example, press the tiltable bread flap downward from the removal position. If the operator presses the tiltable bread flap as far as into the working position, the spring mechanism causes the tiltable bread flap to no longer be pressed in the direction of the removal position by the other spring mechanism. The two spring mechanisms therefore work counter to one another, with the effect of the one spring mechanism predominating in the vicinity of the working position and the effect of the other spring mechanism predominating in the removal position.

The term spring mechanism is understood by a person skilled in the art to mean a suitable mechanism which exerts a spring force, in particular a leaf spring, a spiral spring, a piston cylinder, pneumatic cylinder or hydraulic cylinder and further known spring mechanisms.

In one aspect, no mechanical connecting element or no mechanical connecting elements is/are present between the cover and the lever mechanism, in particular between the contact element of the lever and the pressure element of the cover, which, when the cover is moved from the closed state into the open state, transfers/transfer the movement of the cover to a movement of the lever.

In one aspect, in the closed state of the cover, the spring force of the lever mechanism permanently presses the contact element of the lever against the pressure element of the cover.

In one aspect, in the open state of the cover, the contact element of the lever and the pressure element of the cover do not touch one another.

In one aspect, in the open state of the cover, the cover and the lever mechanism, in particular the contact element of the lever and the pressure element of the cover, are not connected to one another via one or more further levers.

In one aspect, the lever can be moved in a vertical plane which runs parallel to the lateral machine housing. In each position, the lever extends in its longitudinal direction in this plane.

In one aspect, the axis of rotation of the tiltable bread flap and the knife gap are oriented parallel to one another.

In one aspect, the first chute region is formed only by the tiltable bread flap.

In one aspect, the spring is a piston-cylinder spring. One end of the piston-cylinder spring is fastened to the machine housing. The lever mechanism converts the linear piston movement into a rotational movement via a deflection device and effects a rotational movement of the shaft.

In one aspect, the spring of the spring mechanism which presses the tiltable bread flap into the removal position is a spiral spring. The spiral spring is attached on the shaft, to which the tiltable bread flap is rigidly fastened. One end of the spiral spring is fastened to the machine housing, such that the spring force acts against the machine housing. The spring force causes a rotational movement of the shaft.

In one aspect, the slicer comprises a chute bottom which forms an accessible region within the machine housing. The chute bottom at least partially forms the second chute region.

In one aspect, the chute bottom comprises a second chute bottom region which at least partially forms the second chute region. The chute bottom comprises a first chute bottom region. The second chute bottom region is arranged on one side of the knife gap, and the first chute bottom region is arranged on the other side of the knife gap. The first chute bottom region has an offset with respect to the second chute bottom region. Thus, the first chute bottom region forms a plane which is parallel and downwardly offset with respect to the plane of the second chute bottom region. The first chute bottom region is arranged below the tiltable bread flap. When the tiltable bread flap is located in its working position, it runs parallel above the first chute bottom region.

In one aspect, the chute for the material to be sliced is rotated between 10° and 30° in the plane of the chute bottom, in particular in the plane of the second chute bottom region. The angle of rotation is the angle between the longitudinal direction of the chute for the material to be sliced and the plane of the lateral machine housing. In one aspect, the chute for the material to be sliced is rotated between 15° and 25° in the plane of the chute bottom, in particular in the plane of the second chute bottom region. In one aspect, the chute for the material to be sliced is rotated between 18° and 22° in the plane of the chute bottom, in particular in the plane of the second chute bottom region. In order to illustrate the direction of rotation of the chute for the material to be sliced, it is the case, for one aspect in which the chute bottom is oriented horizontally, that the chute for the material to be sliced is rotated in the horizontal plane with respect to the lateral machine housing. This has the advantage that a rotation of the chute for the material to be sliced permits an increase in the maximum slices per unit time, i.e. an increase in the maximum slices per minute, in the case of a predetermined compact construction of the slicer, in particular in the case of a predetermined width of the machine housing, and in the case of a predetermined bread size. Here, an angle of rotation between 10° and 30° has proven to be advantageous. An angle of rotation between 15° and 25° has proven to be particularly advantageous. An angle of rotation between 18° and 22° has proven to be very particularly advantageous.

In one aspect, the chute bottom is inclined with respect to the plane of the lateral machine housing, such that the plane of the lateral machine housing and the chute bottom are arranged at an angle of between 50° and 70°, in particular between 55° and 65°, with respect to one another. This is advantageous if the chute bottom has a boundary on one side. Due to the inclination, the natural sliding direction of the bread, caused by gravity, is in the direction of this boundary. During the slicing operation, the knife also presses the bread in the direction which, due to the inclination of the chute, corresponds to the sliding direction of the bread. This allows a particularly clean slice.

In one aspect, the knife gap runs in the plane of the chute bottom and perpendicularly with respect to the longitudinal direction of the chute for the material to be sliced.

In one aspect, the lever is connected to the shaft at a stationary pivot point. The connection has a joint. Thus, the angle between the shaft and the lever can be changed during the movement of the lever from the removal position, in which the tiltable bread flap is located in the removal position, into the working position, in which the tiltable bread flap is located in the working position. Thus, during the movement, the lever is always oriented with its longitudinal direction in a vertical plane which runs parallel to the lateral machine housing.

In one aspect, the shaft has two flattened sides at the stationary pivot point of the joint. The lever has a fork at the point of connection to the shaft. The fork engages over the flattened sides of the shaft. As a result, a torque can be exerted on the shaft by the lever. For the connection between the shaft and the fork, a pin penetrates the shaft and the fork in a perpendicular orientation with respect to the flattened sides and forms a joint which brings about a connection between the fork and the shaft, which connection is rotatable in the longitudinal direction of the shaft.

In one aspect, a guide element is provided on the machine housing, which guide element forms a guide for the lever. During the movement, the guide element orients the lever with its longitudinal direction in a vertical plane which runs parallel to the lateral machine housing.

In one aspect, the guide element has the shape of a square tube, from which a guide rail is cut out. The cutting angle of the guide rail corresponds to the angle by which the chute bottom is inclined with respect to the plane of the lateral machine housing. The guide rail runs parallel to the plane of the lateral machine housing.

In one aspect, the slicer comprises a feed unit, wherein the feed plate is part of the feed unit. The feed unit comprises a gripper for gripping and holding a loaf of bread on the feed plate. The gripper comprises gripping prongs which are rotatably mounted on the feed unit. In the open state of the gripper, the gripping prongs are substantially covered by the feed plate. In the closed state of the gripper, the gripping prongs project out of the feed plate. By means of a gripper motor, the gripper moves from the open state into the closed state by a rotational movement of a gripper shaft. The gripping prongs are mechanically fixedly connected to the gripper shaft. The gripper motor has a fixed position relative to the machine housing. The gripper motor can be coupled to the feed unit via a coupling when the feed unit is located in an initial position.

In one aspect, the gripper motor and the feed unit are not coupled via the coupling when the feed unit moves with the feed plate in the longitudinal direction of the chute for the material to be sliced.

In one aspect, the coupling is formed by a slot at the end of the motor shaft, into which slot a flattened tip of the gripper shaft, shaped like a slot screwdriver, can be introduced. The flattened tip of the gripper shaft and the slot of the motor shaft can be connected in a form-fitting manner.

In one aspect, in a closed position of the gripper motor, the slot of the coupling extends along the direction of movement of the feed plate. In an open position of the gripper motor, the slot of the coupling is rotated by at least 75°, preferably by at least 90°, relative to the closed position.

In one aspect, the gripper motor is located behind a cover which separates the chute for the material to be sliced from the rest of the machine housing. The motor shaft of the gripper motor projects through a round opening of the cover, wherein the coupling is attached on that side of the cover on which the chute for the material to be sliced is located.

This has the advantage that the feed plate can be moved along the longitudinal direction of the chute for the material to be sliced, without the gripper motor having to move correspondingly in the interior of the machine housing. The gripper motor is used only when a new material to be sliced is to be gripped or a residual piece of material to be sliced is to be removed from the gripper. This is always at the same point along the longitudinal direction of the chute for the material to be sliced. For this reason, the gripper motor can remain in a fixed position relative to the chute for the material to be sliced. This has considerable hygiene advantages, since only a small opening for the motor shaft of the gripper motor has to exist from the inner region of the machine housing to the hygiene region, and not a slot which has to extend over almost the entire second chute region. In one aspect, the motor shaft is a shaft driven by the gripper motor, in particular a shaft formed separately from the gripper motor and mechanically connected to the gripper motor.

In one aspect, the first chute region comprises a tiltable bread flap which is part of the first chute region or forms the first chute region. In a working position, the tiltable bread flap continues the second chute region in the longitudinal direction. In a removal position, the bread flap is tilted about an axis of rotation in comparison with the working position. The slicer comprises a slice support which can be moved in the longitudinal direction of the chute for the material to be sliced. The slice support has an undulating or serrated contour in the plane perpendicularly with respect to the longitudinal direction of the bread chute. One end edge of the bread flap is of undulating or serrated design. In one aspect, this is that end edge of the bread flap which is remote from the knife gap in the longitudinal direction of the chute for the material to be sliced.

In one aspect, the elevations and depressions of the undulating or serrated contour of the slice support run in their longitudinal direction perpendicularly with respect to the contact surface of the bread flap.

In one aspect, the wavelength and/or the amplitude of the undulating or serrated end edge of the bread flap corresponds to the wavelength and/or amplitude of the undulating or serrated contour of the slice support.

In one aspect, the plane of the slice support is arranged perpendicularly with respect to the longitudinal direction of the chute for the material to be sliced. In their working position, the bread flap and the slice support are arranged at right angles.

In one aspect, in a rest position of the slicer, the slice support is arranged in the longitudinal direction of the chute for the material to be sliced at a position in which the undulating or serrated end edge of the bread flap engages into the undulating or serrated contour of the slice support, in particular engages when the tiltable bread flap is tilted from the working position into the removal position.

The slicer is located in a rest position when no slicing process is currently taking place. This can be, for example, before the filling of the slicer with material to be sliced or else after a slicing process has been completed and the sliced material to be sliced has not yet been removed.

In one aspect, the slice support is movable along the longitudinal direction of the first chute region when the tiltable bread flap is in the working position. The slice support can be moved above the contact surface of the bread flap.

In one aspect, the undulating edge of the bread flap comprises between two and five wave troughs, in particular three wave troughs.

Some aspects of the present disclosure are shown by way of example in the drawings and described below.

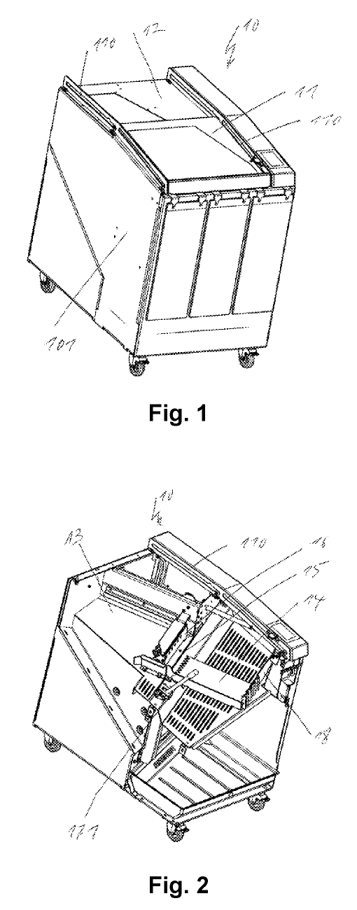

FIG. 1 shows a slicer 10 according to the present disclosure. The slicer 10 comprises a machine housing. The machine housing defines a cross section, the footprint, in the horizontal plane. This cross section corresponds to the area required by the slicer, for example in a bakery or a supermarket, as an installation area. In the view of FIG. 1, an operator is located on the front, shorter side of the slicer 10, that is to say this side is the operator side. The slicer comprises a lateral machine housing 101 which lies in a plane which runs rearward away from the operator. The slicer comprises a cover 11 which is displaceable in rearwardly running rails 110. In FIG. 1, the cover 11 is in a closed state. In a closed state, the cover 11 conceals the access to a chute for the material to be sliced. If the cover 11 is pushed rearward on the rail track 110, it at least partially opens up the access to the chute for the material to be sliced. The slicer comprises a further, fixed cover 12 which is located further to the rear on the machine housing and which covers a further part of the chute for the material to be sliced. The cover 11 can be displaced with the aid of the rails 110 over the further, fixed cover 12 in order to move it into the open state. FIG. 2 shows the slicer 10, with some parts of the machine housing being blanked out to show components which are located inside the machine housing. The slicer 10 comprises a chute for the material to be sliced with a first chute region 14 and a second chute region 13. The two chute regions 13, 14 of the chute for the material to be sliced are at least partially separated from one another by a knife gap 15. The cutting knife can be moved out of the knife gap 15 into the chute for the material to be sliced. By means of a feed unit 16 with a feed plate, the material to be sliced can be moved in the longitudinal direction of the chute for the material to be sliced. The slicer 10 comprises a slice support 18 which is movable in the longitudinal direction of the chute for the material to be sliced. The slice support 18 forms a counter-holder for the material to be sliced and supports the cut-off bread slices, in particular during and after the slicing process, and thus prevents them from falling over. The first chute region 14 is designed as a tiltable bread flap 14. The tiltable bread flap 14 is tiltable about an axis of rotation. Furthermore, FIG. 2 shows a lever 171 of a lever mechanism for moving the tiltable bread flap 14 from a removal position into a working position.

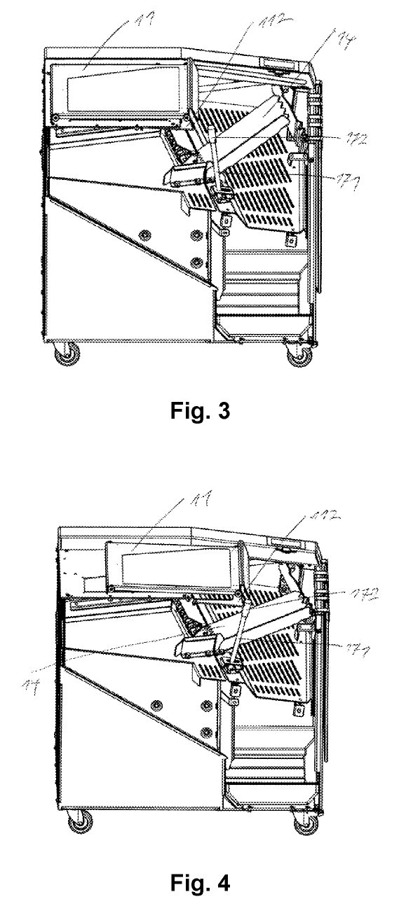

FIGS. 3-5 show the slicer in a side view, that is to say in a view of the lateral machine housing 101. In FIG. 3, the cover 11 is located in an open state, that is to say the cover 11 is displaced rearward on the rails and opens up the access to the chute for the material to be sliced. The tiltable bread flap 14, which is part of the first chute region, is tilted into a removal

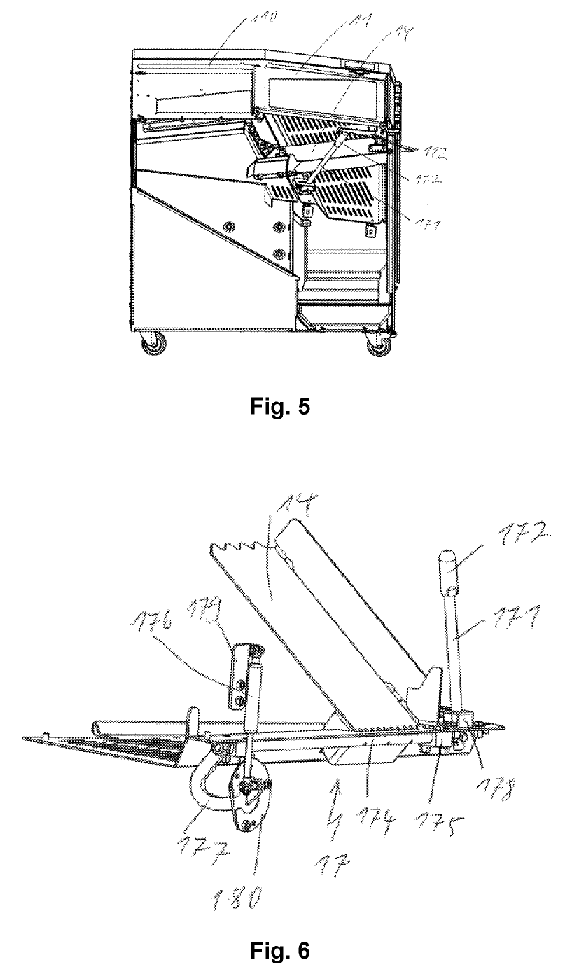

position. This means that the tiltable bread flap is tilted upward about an axis of rotation toward the opening which is opened up by the cover 11. The lever 171 of the lever mechanism comprises a contact element 172, which can be brought into mechanical interaction with a pressure element 112 of the cover 11. This is not the case in FIG. 3, since the cover 11 is located in its open state, in particular in its completely open state. In this state, there is no mechanical connection at all between the cover and the bread flap via the lever mechanism. There is no mechanical connecting element between the cover and the lever mechanism and thus between the cover and the bread flap. In FIG. 4, the cover 11 is pulled closed to a small extent, that is to say it is located at a point between its open state and its closed state. At this point, the pressure element 112 of the cover 11 and the contact element 172 of the lever 171 make contact with one another. When the cover 11 is moved from the open state into the closed state by being pulled forward by the operator from the rear region of the slicer, the pressure element 112 of the cover 11 makes contact with the contact element 172 of the lever 171. If the movement of the cover 11 in the direction of the closed state is continued by the operator, the mechanical contact between the pressure element 112 of the cover 11 and the contact element 172 of the lever 171 remains from now on. The lever 171 is moved further and further by the pressure element 112 of the cover 11, and the tiltable bread flap 14 is pressed further downward in the direction of the working position. FIG. 4 shows a state in the case of this movement. The elongate shape of the pressure element 112 with a stop lug takes account of the geometric fact that the lever 171 rotates about a pivot point and the cover 11 is displaced substantially linearly in the rails on the machine housing. FIG. 5 shows the cover 11 in a closed state, that is to say after the operator has moved the cover 11 from the open state (FIG. 3) via the state shown in FIG. 4 as far as the completely closed state. In FIG. 5, the pressure element 112 of the cover 11 presses the contact element 172 of the lever 171 and thus also the lever 171 into its foremost position. There is permanent contact between the pressure element 112 of the cover 11 and the contact element 172 of the lever 171. However, there is no permanent fixed connection in the sense of a screw connection, a joint, a holder in a rail track or a piston cylinder. Since the lever mechanism comprises a spring which presses the lever against the pressure element 112 of the cover 11, there is only contact between the pressure element 112 of the cover 11 and the contact element 172 of the lever 171. In FIG. 5, the tiltable bread flap is pressed into its working position by means of the lever mechanism.

FIGS. 6 to 8 show the lever mechanism 17. The lever mechanism 17 comprises the lever 171 with the contact element 172. The lever 171 is connected via a joint 173 to an axis of rotation 174. Furthermore, the lever mechanism 17 comprises a guide element 178 which forms a guide for the lever 171. During the movement, the guide element 178 orients the lever 171 with its longitudinal direction in a vertical plane which runs parallel to the lateral machine housing 101.

The tiltable bread flap 14 is rigidly fastened to the axis of rotation 174. That is to say, if the axis of rotation 174 is rotated via the lever 171, this leads to tilting of the tiltable bread flap 14. In particular, the axis of rotation 174 is a shaft. Furthermore, near the left and right ends of the axis of rotation 174, there are holders 175 by way of which the axis of rotation is connected rotatably to the machine housing. The lever mechanism 17 furthermore comprises a spring 176 which permanently exerts a spring force and presses the tiltable bread flap 14 in the direction of the removal position. The spring 176 is designed as a hydraulic piston, one end of which is fastened to the machine housing by way of a fastening 179. This is a passive hydraulic spring, that is to say it is a closed system which has no external controller or hydraulic connections. The other end of the spring 176 is fastened to a deflection element 177 which converts the linear movement of the hydraulic piston into a rotational movement on the axis of rotation 174. The deflection element 177 is fastened to the machine housing via a guide 180, wherein the guide 180 defines the direction of movement of the deflection element 177.

In FIG. 6, the tiltable bread flap 14 is located in its removal position, that is to say the cover 11 is located in the open state, as shown in FIG. 3.

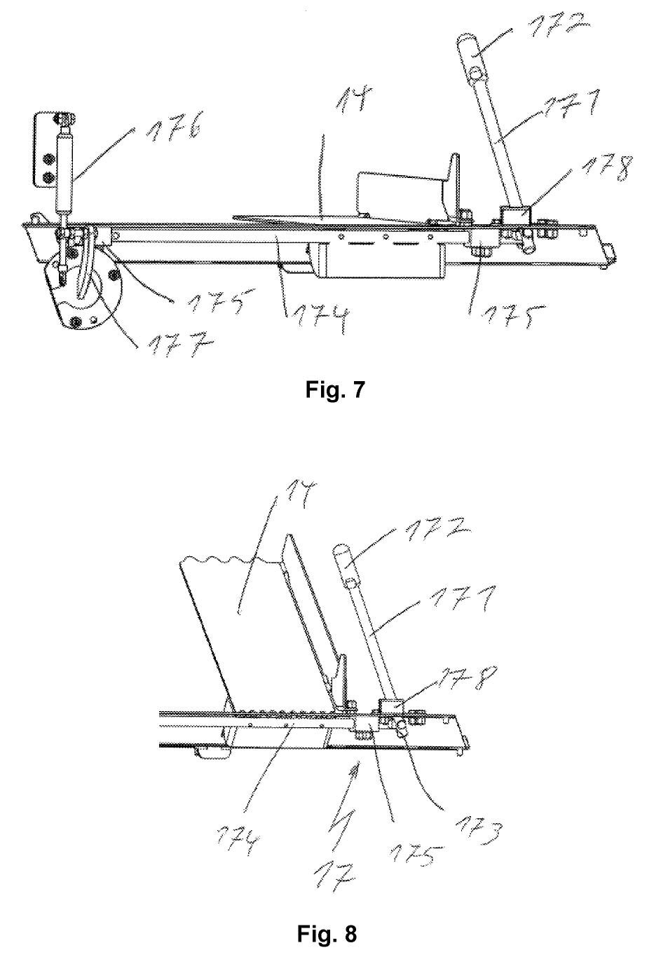

In FIG. 7, the tiltable bread flap 14 is located in its working position, that is to say it continues the second chute region 13 (FIG. 2) in its longitudinal direction beyond the knife gap 15 (FIG. 2) as the first chute region 14. This is the case when the cover 11 is located in the closed state, as shown in FIG. 5.

FIG. 8 shows again, in a similar manner to FIG. 6, the lever mechanism 17 when the tiltable bread flap 14 is located in the removal position. FIG. 8 shows the same perspective as FIG. 7. The effect of the joint 173 can be seen in these matching perspectives. The axis of rotation 174 has a longitudinal direction which does not lie in a horizontal plane. The lever 171 has a direction of movement which lies in a vertical plane. The plane in which the axis of rotation 174 lies and the plane in which the lever 171 moves are not arranged at right angles to one another. For this reason, during the movement of the lever 171 and the rotation of the axis of rotation 174, the joint 173 permits an angular change between the lever 171 and the axis of rotation 174.

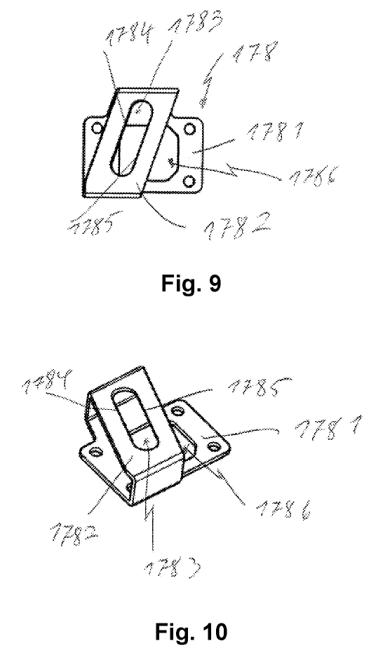

FIGS. 9 and 10 show the guide element 148 which orients the lever 171 during the movement with its longitudinal direction in a vertical plane which runs parallel to the lateral machine housing 101. The guide element 148 is produced from a square tube by means of laser cutting. It comprises a holding plate 1781, by way of which the guide element is fastened to the chute for the material to be sliced. The guide element 178 is therefore attached in accordance with the inclination of the chute for the material to be sliced with respect to the vertical plane. The holding plate 1781 comprises an opening 1786, through which the lever 171 projects. The guide element 178 comprises a guide plate 1782 which comprises a guide rail 1783, in which the lever 171 is guided. Since the inclination of the chute for the material to be sliced and thus the inclination of the guide element 178 and the guide plate 1782 are not at right angles to the plane of the lateral machine housing 101, the edges 1784, 1785 of the guide rail 1783 are cut in such a way that they run along a vertical plane. Accordingly, they are not at right angles to the guide plate 1782. This allows jolt-free guidance of the lever 171. Since the knife gap 15 and thus also the axis of rotation 174 of the lever mechanism 17 likewise extend in a direction which is not at right angles to the plane of the lateral machine housing 101, the guide rail 1783 is arranged obliquely in comparison with the original orientation of the square tube from which the guide element has been cut. Thus, in its longitudinal direction, the holding plate 1781 is oriented on and attached to the chute for the material to be sliced parallel to the knife gap 15. To this end, the guide rail 1783 is rotated at an angle which corresponds to the rotation of the knife gap 15 in comparison with the plane of the lateral machine housing 101. This ensures that the lever 171 moves in a vertical plane. This ensures that, during the movement, the contact element 172 of the lever 171 always follows the direction of movement of the pressure element 112 of the cover, which, during the linear movement of the cover 11 along the rails 110, always moves in a plane parallel to the lateral machine housing 101.

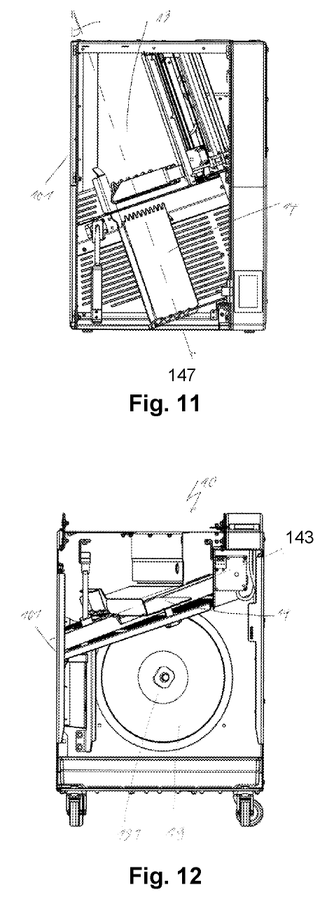

FIG. 11 shows the slicer 10 in a view from above without the covers 11, 12. The first chute for the material to be sliced 14 and the second chute for the material to be sliced 13 are shown. The longitudinal direction 147 thereof is shown by the dashed line. In addition, the lateral machine housing 101 is shown. The longitudinal direction 147 of the chute for the material to be sliced forms an angle of approximately 20° with the lateral machine housing. FIG. 12 shows the slicer in a view from the front, i.e. at the location where an operator is located when using the slicer. The front covers of the machine housing are blanked out in this view. The circular knife 19 can be seen outside the chute for the material to be sliced. A hub 191 is shown, by way of which the circular knife is fastened to a knife arm. The knife arm is driven and rotates in a circular movement about a pivot point. The circular knife 19 is attached by way of the hub 191 to the end of the knife arm remote from the pivot point. The circular knife 19 rotates with the hub 191 about its own center point. The chute bottom is inclined in a transverse direction 143 with respect to the lateral machine housing 101 by an angle of approximately 60°.

FIG. 11 shows the spatial orientation of the chute for the material to be sliced. The rotation of the chute for the material to be sliced allows a particularly compact dimension, in particular compact width, of the slicer 10. Circular knives 19 which meet a certain standard are available on the market. These have, for example, a circular knife diameter of 420 mm. Often, this circular knife diameter should not be changed during the construction of a machine, such that no special fabrications of circular knives have to be used. This circular knife is carried by way of its center point by the knife arm, and is moved on a circular path about the pivot point of the knife arm. Here, the circular knife rotates around its own center point. The outermost circle radius, on which the cutting edge of the circular knife 19 moves, consequently lies on a circular path with a radius about the pivot point, which radius substantially corresponds to the sum of the length of the knife arm and the radius of the circular knife 19. This circular path with its radius has to fit in the machine housing. If particular importance is attached to a compact design of the slicer 10, and if the machine 10 is intended to be optimized in such a way that the machine housing has a width which is as small as possible or a predetermined standard width, the circular path on which the outer cutting edge moves can only be reduced, in the case of a standard circular knife and thus in the case of a predetermined radius of the circular knife 19, if the length of the knife arm is reduced. Thus, in the prior art, there is a trade-off between the length of the knife arm and the width of the machine housing. Reducing the width of the machine housing often corresponds to the customer preference, as they prefer a compact design. The length of the knife arm has direct effects on the duration for which the circular knife 19 is not located within the chute for the material to be sliced. The circular knife 19 is moved around the pivot point on a circular path, wherein on one part of this path it penetrates through the knife gap 15 into the chute for the material to be sliced and slices material to be sliced, and on another part of this path it is located in the machine housing outside the chute for the material to be sliced. As long as the circular knife 19 is located outside the chute for the material to be sliced, the material to be sliced can be fed by the feed unit 16 in order to cut the next slice. The time required to move the bread further by the feed unit 16 is reduced as the number of revolutions of the knife arm about the pivot point increases. A slice is cut with each rotation of the knife arm. Therefore, it is desirable to optimize the number of revolutions of the knife arm upward in order to cut as many slices as possible in a short time. This also corresponds to the customer preference. For example, 120 cuts per minute are often to be achieved and thus 120 revolutions of the knife arm per minute. Here too, a trade-off is seen in the dimensioning of the knife arm. For reasons of compact construction, the length of the knife arm should be as small as possible. In order to be able to increase the number of cuts per minute with the same feed time for the feed unit, the length of the knife arm should be as long as possible. The inventor has recognized this contradiction, and has recognized that, upon rotation of the chute for the material to be sliced, the plane in which the circular knife 19 moves also rotates. By rotating the plane in which the circular knife moves, the effective circle diameter of the circular knife 19, namely the diameter of the circular path on which the cutting edge of the knife moves, can be increased equally. Thus, with the same circular knife diameter, the knife arm can be lengthened, which leads to an increase in the maximum number of cuts. However, the extent to which the chute for the material to be sliced can be rotated is also limited by the fact that the bread to be sliced has to fit both in the first chute region 13 and in the second chute region 14. A certain minimum length of both chute regions is therefore ensured. If the machine housing is dimensioned with a width which is significantly smaller than its depth, for example in the case of a machine with the cross section of the machine housing of 60 cm width and 90 cm depth, which often corresponds to the specification of the customer, there is a restriction to what extent the chute for material to be sliced can be rotated due to the bread length. In the prior art, the longitudinal direction of the slicer is often along the long side of the machine housing, in order that the first chute region and the second chute region are long enough for the material to be sliced. The short side of the machine housing then determines the length of the knife arm via the maximum effective circle diameter. In a manner derived herefrom, an attempt is made to achieve an optimum by mechanical optimization of the feed mechanism, by the arrangement of the knife slot, by the selection of the knife motor and its optimization by powerful, expensive components and by limitations of the possible number of slices per minute. In contrast, the rotation according to the present disclosure of the knife slot has the advantage of being able to increase the number of slices per minute without having to resort to expensive components for the knife motor, knife and feed mechanism.

FIG. 13 illustrates this relationship for a circular knife diameter of 420 mm and a dimension of the machine housing on the inside of a width of 573 mm and a length of 840 mm.

As a function of the rotation of the chute for the material to be sliced in the plane of the chute bottom, an angle is obtained between the longitudinal direction 147 of the chute for material to be sliced and the plane of the lateral machine housing 101. As a function of this angle (x-axis), FIG. 13 shows the maximum bread length which can still be cut (left-hand y-axis) and a measure of the time which remains to move the bread further (right-hand y-axis). This is based on a given number of slices per minute of 120. This measure of time is the angle of rotation of the knife without knife engagement. This corresponds to the portion of the circular movement of the knife arm in which the knife edge does not project through the knife gap 15 and thus does not reach into the chute for the material to be sliced. Only while the knife arm is located on this part of its circular movement can the bread be moved by the feed unit 16. In order to be able to reduce the requirements on the feed unit 16, this angle of rotation, that is to say this part of the circular movement of the knife arm, should be as great as possible; the longer is the time that remains to move the bread. The right-hand y-axis should therefore be considered a measure of the time remaining to move the bread by the feed unit 16. The resulting maximum bread length is shown in FIG. 13 by the line 1402. The measure of the time in which the bread can be moved on by the feed unit 16 because the circular knife 19 does not engage in the chute for the material to be sliced during this time is shown by the line 1403. The inventor has now determined that, when the chute bottom is rotated in the plane of the chute bottom by 20° (dashed line 1405), the requirements for the maximum bread length and the requirements for the time in which the knife does not engage in the chute for the material to be sliced are met. The maximum bread length is shown at the point of intersection 1404 in FIG. 13. The measure of the time in which the knife does not engage in the chute for the material to be sliced is shown at the point of intersection 1406. This can be converted directly into the part of a second which remains for the feed of the material to be sliced.

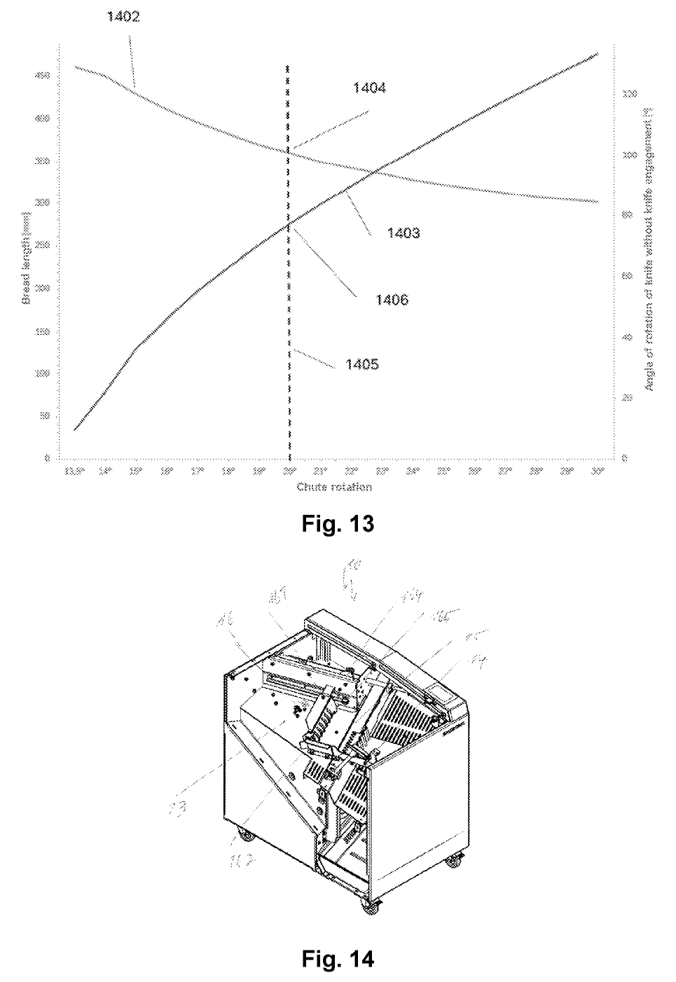

FIG. 14 shows the slicer 10 with a view of the chute for the material to be sliced. The first chute region 14 and the second chute region 13 as well as the knife gap 15 lying between them are shown. FIG. 14 shows the feed unit 16 with its feed plate 161, against which the material to be sliced rests and by means of which the material to be sliced can be moved in the longitudinal direction of the chute for the material to be sliced. Here, a gripper motor 165 has a fixed position within the machine housing for opening and closing gripping prongs of a gripper. The gripper motor 165 is connected to the gripper via a coupling 164, wherein the coupling 164 has a fixed position within the chute for the material to be sliced.

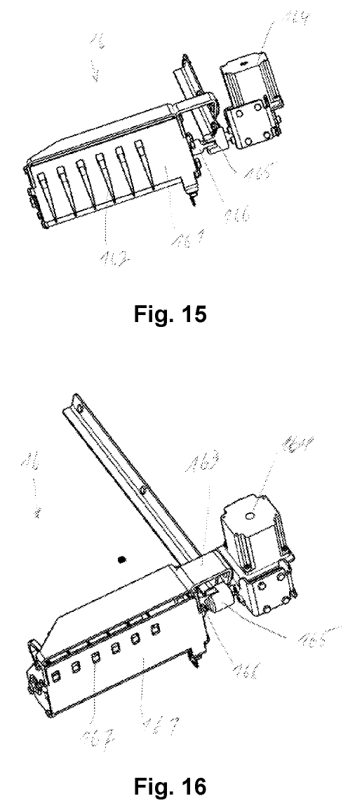

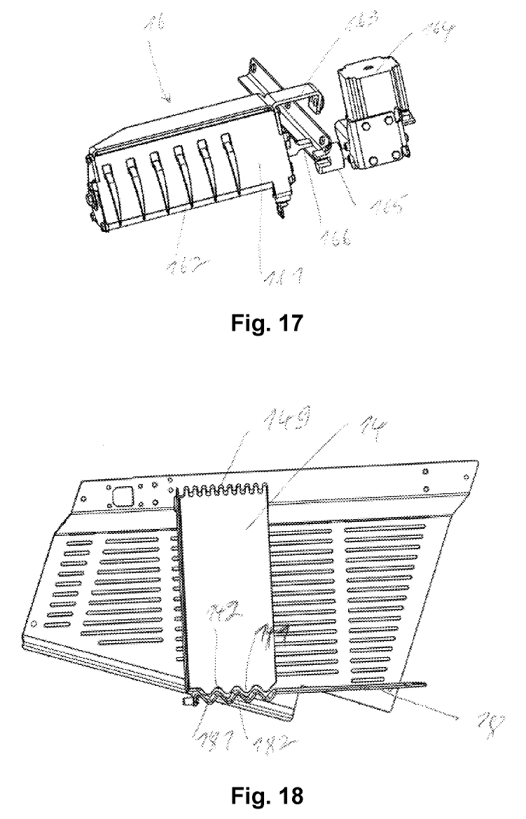

FIGS. 15-17 show the feed unit in various states and positions. FIG. 15 shows the feed unit 16 in an initial position, in which it is coupled to the gripper motor via the coupling 165. The coupling 165 is formed as a rotatable fork. This is realized as a slot at the end of the shaft, which is driven by the gripper motor. The feed unit 16 comprises a gripper shaft 166 which has two flattened sides running in parallel at its end. The gripper shaft 166 is shaped at its end like a slot screwdriver. This flattened end of the gripper shaft 166 can be introduced into the slot of the coupling 165 in a form-fitting manner. In FIG. 15, the gripper shaft 166 is introduced into the coupling 165 due to the position of the feed unit 16 in its initial position. The orientation of the coupling 165 is such that the fork is oriented in the direction of the longitudinal direction of the chute for the material to be sliced. In this orientation, the gripper is in a closed state, and the gripping prongs 162 project through the feed plate 161. FIG. 16 likewise shows the feed unit 16 in the initial position, just as in FIG. 15. In FIG. 16, however, the gripper is in its open state. This means that the coupling is rotated by 90°, such that the fork is now perpendicular with respect to the longitudinal direction of the chute for the material to be sliced. In this position, the feed unit cannot be moved in the longitudinal direction of the chute for the material to be sliced, since the gripper shaft 166 cannot move out of the coupling in the longitudinal direction of the chute for the material to be sliced. By rotating the coupling 165 in comparison with the position in FIG. 15, the gripper shaft 166 is also rotated. The gripping prongs 162 are mechanically connected to the gripper shaft 166 and, upon rotation of the gripper shaft 166, they are set into rotational motion. Thus, the gripping prongs 162 are now arranged behind the feed plate 161 by corresponding rotation of the gripper shaft 166 and are largely concealed by them in FIG. 16. However, openings 167 can be seen in the feed plate 161, through which openings the gripping prongs 162 move out of the feed plate 161 when the gripper shaft 166 is rotated. In FIG. 17, the gripper is located in its closed state, as in FIG. 15. The gripping prongs 162 project out of the feed plate 161 and can thus grip a material to be sliced. The feed unit 16 is not located in its initial position in FIG. 17, but rather is moved by a motor along the chute for the material to be sliced. A drive unit can move the feed unit 16 with the aid of the holder 163 along the chute for the material to be sliced, in order to move material to be sliced across the knife gap in the longitudinal direction of the chute for the material to be sliced. The coupling 165 is located in its position as in FIG. 15, such that the flattened end of the gripper shaft 166 can be moved into and out of the fork of the coupling 165 by a linear movement along the longitudinal direction of the chute for the material to be sliced. The slicing operation takes place in this position. When the feed unit 16 is moved back into its initial position, the flattened end of the gripper shaft 166 moves into the coupling 165.

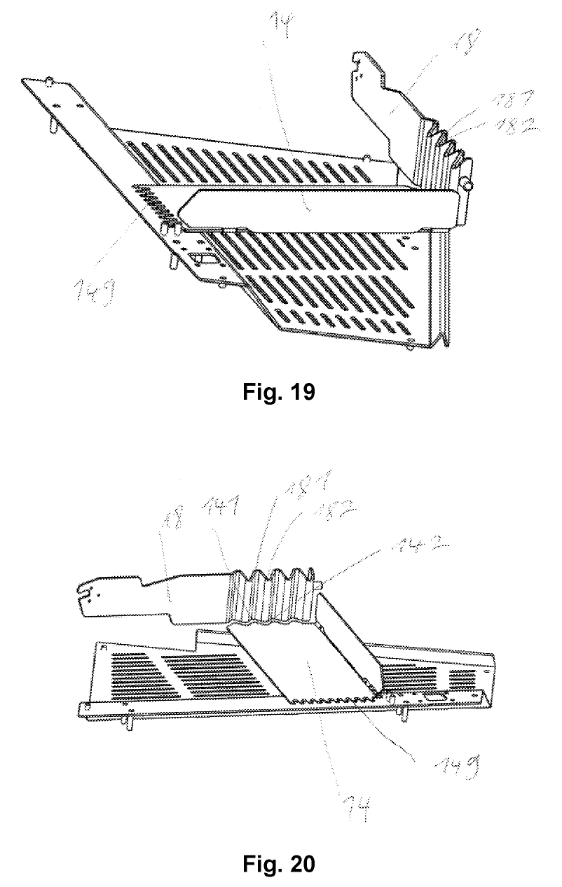

FIG. 18 shows the tiltable bread flap 14 in the working position. This means that the bread flap continues the first chute region as the second chute region and is not tilted at its axis of rotation 149. The view has a perpendicular direction of view with respect to the second chute region of the chute for the material to be sliced. The tiltable bread flap 14 has an end edge of undulating formation at the end opposite the axis of rotation 149 in the longitudinal direction of the chute for the material to be sliced. That is to say, the end edge is not of rectilinear design, but rather has regular indentations 142 and projections 141. Furthermore, the slice support 18 is shown, which is likewise located in an initial position in this view. It is located in the region of the end edge of undulating formation of the tiltable bread flap. The slice support has an undulating contour of depressions 181 and elevations 182. The depth and width of the elevations 182 and depressions 181 of the slice support 18 substantially correspond to the depth and the width of the projections 141 and indentations 142 of the tiltable bread flap 14. FIG. 19 shows the tiltable bread flap 14 and the slice support in the position as in FIG. 18, but as a side view. FIG. 20 shows the tiltable bread flap 14 and the slice support in the position as in FIGS. 18 and 19, but in a view in the longitudinal direction of the chute for the material to be sliced.

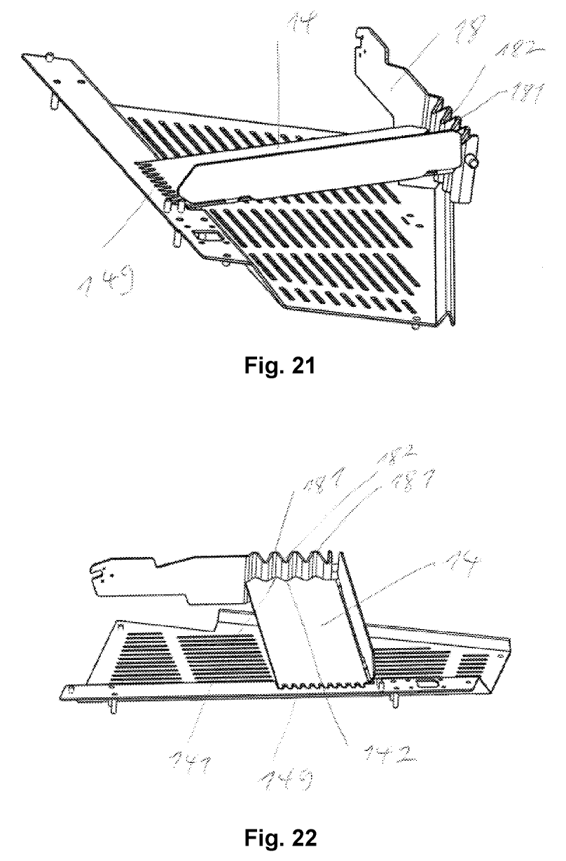

FIG. 21 shows the tiltable bread flap and the slice support in a view as in FIG. 19. FIG. 22 shows the tiltable bread flap and the slice support in a view as in FIG. 20. FIGS. 21 and 22 differ from FIGS. 19 and 20 in that the tiltable bread flap 14 is tilted slightly upward, and the end edge of the tiltable bread flap 14 is located at the height of the slice support 18. This position is a transition position when the tiltable bread flap 14 is transferred from its working position into the removal position. In this case, it should pass the slice support 18. The configuration of the end edge of the tiltable bread flap 14 with indentations 142 and projections 141 and the configuration of the slice support 18 with an undulating contour of depressions 181 and elevations 182 leads to the end edge of the tiltable bread flap 14 and the slice support 18 being able to engage into one another when the tiltable bread flap 14 is transferred from the working position into the removal position. The slice support does not impede the movement of the tiltable bread flap 14. At the same time, it can be seen in FIG. 18 that there is no straight continuous gap, into which a slice could slip and become jammed, between the end edge of the tiltable bread flap 14 and the slice support 18, which is located in its initial position, as a result of the interacting indentations 142 and projections 141 of the tiltable bread flap and the undulating contour of depressions 181 and elevations 182 of the slice support 18. In particular, this advantage is particularly valuable if the tiltable bread flap 14 is moved past the slice support 18 and jamming becomes even more probable as a result of this movement.

The functions of various elements shown in the drawings, including the function blocks, can be realized by dedicated hardware or by generic hardware capable of executing software, in conjunction with the corresponding software. If the functions are provided by means of a processor, they can be provided by a single dedicated processor, a single shared processor, or a plurality of generic processors, which can in turn be shared. The functions can be provided, without limitation, by a digital signal processor (DSP), network processor, application specific integrated circuit (ASIC), field programmable gate array (FPGA), read only memory (ROM) with stored software, random access memory (RAM), and non-volatile memories.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A slicer for cutting off slices of material to be sliced, the slicer comprising:
a machine housing, which encloses a drive motor and a circular knife, the circular knife being supported by a knife arm and being rotatably fastened to the knife arm;
a chute for the material to be sliced, the chute being configured to receive the material to be sliced, the material to be sliced being movable in a longitudinal direction of the chute for the material to be sliced by a feed plate, the chute for the material to be sliced comprising a first chute region and a second chute region, the first chute region of the chute for the material to be sliced and the second chute region of the chute for the material to be sliced being at least partially separated by a knife gap;
a tiltable bread flap, which is part of the first chute region or forms the first chute region, the tiltable bread flap continuing the second chute region in the longitudinal direction in a working position, the bread flap being tiltable about an axis of rotation in a removal position in comparison with the working position;
a cover, which at least partially opens up access to the chute for the material to be sliced in an open state and covers the chute for the material to be sliced in a closed state;
a lever mechanism configured to move the tiltable bread flap from the removal position into the working position,
wherein the lever mechanism is configured to transfer the tiltable bread flap from the removal position into the working position when the cover is moved from the open state into the closed state, and
wherein there is no mechanical connection between the cover and the lever mechanism in the open state.

2. The slicer as claimed in claim 1, wherein the lever mechanism comprises a spring which is configured to permanently exert a spring force, wherein the spring force is configured to press the tiltable bread flap in the direction of the removal position.

3. The slicer as claimed in claim 1, wherein the axis of rotation is a shaft, to which the tiltable bread flap is rigidly fastened.

4. The slicer as claimed in claim 1,
wherein the lever mechanism comprises a lever, which extends in the machine housing from the axis of rotation in the direction of the cover,
wherein an end of the lever that is remote from the axis of rotation is designed as a contact element or comprises a contact element, and
wherein the cover comprises a pressure element, which is provided to make contact with the contact element of the lever mechanism and to actuate the lever when the cover is moved from the open state to the closed state.

5. The slicer as claimed in claim 4, wherein no mechanical connecting element or mechanical connecting elements is/are present between the cover and the lever mechanism, including between the contact element of the lever and the pressure element of the cover, the connecting element or elements, when the cover is moved from the closed state into the open state, is/are configured to transfer the movement of the cover to a movement of the lever.

6. The slicer as claimed in claim 4, wherein, in the closed state of the cover, the spring force of the lever mechanism is configured to permanently press the contact element of the lever against the pressure element of the cover.

7. The slicer as claimed in claim 4, wherein, in the open state of the cover, the contact element of the lever and the pressure element of the cover are not in contact with one another.

8. The slicer as claimed in claim 4, wherein, in a first lever position, the tiltable bread flap is located in the removal position and, in a second lever position, the tiltable bread flap is located in a working position, and the lever is movable between the first lever position and the second lever position.

9. The slicer as claimed in claim 8, wherein a third lever position is present between the first lever position and the second lever position and, when the cover is moved from the open state to the closed state, the pressure element of the cover is configured to make contact with the contact element of the lever when the lever is located in the first lever position, and the lever is movable by the pressure element of the cover as far as into the third lever position, wherein the cover is in the closed state, when the lever is located in the third lever position and the pressure element of the cover and the contact element of the lever are configured to make contact with one another, wherein a spring mechanism is provided which is configured to press the lever from the third lever position into the second lever position.

10. The slicer as claimed in claim 4, wherein, in the open state of the cover, the cover and the lever mechanism, including the contact element of the lever and the pressure element of the cover, are not connected to one another via one or more further levers.

11. The slicer as claimed in claim 1, wherein the lever is movable in a vertical plane which runs parallel to the lateral machine housing, and the lever extends in this plane in its longitudinal direction in every position.

12. The slicer as claimed in claim 1, wherein the axis of rotation of the tiltable bread flap and the knife gap are oriented parallel to one another.

13. The slicer as claimed in claim 1, wherein the first chute region is formed only by the bread flap.

14. The slicer as claimed in claim 3, wherein the spring is a piston-cylinder spring which is fastened at one end to the machine housing, wherein the lever mechanism is configured to convert the linear piston movement into a rotational movement via a deflection device and brings about a rotational movement of the shaft.

15. The slicer as claimed in claim 3, wherein the spring is a spiral spring which is applied to the shaft and is fastened at one end to the machine housing, such that the spring force acts against the machine housing and the spring force brings about a rotational movement of the shaft.

16. The slicer as claimed in claim 1, wherein the slicer comprises a chute bottom which forms an accessible region within the machine housing, wherein the chute bottom at least partially forms the second chute region.

17. The slicer as claimed in claim 16, wherein the chute bottom comprises a second chute bottom region which at least partially forms the second chute region, and wherein the chute bottom comprises a first chute bottom region, wherein the second chute bottom region is arranged on one side of the knife gap and the first chute bottom region is arranged on the other side of the knife gap, wherein the first chute bottom region has an offset with respect to the second chute bottom region, such that the first chute bottom region forms a plane which is parallel and downwardly offset with respect to the plane of the second chute bottom region, wherein the first chute bottom region is arranged below the tiltable bread flap, such that the tiltable bread flap, when it is located in its working position, runs in parallel above the first chute bottom region.

18. The slicer as claimed in claim 16, wherein the chute for the material to be sliced is rotated in in the plane of the second chute bottom region between 10° and 30, wherein the angle of rotation is the angle between the longitudinal direction of the chute for the material to be sliced and the plane of the lateral machine housing.

19. The slicer as claimed in claim 16, wherein the chute bottom is inclined with respect to the plane of the lateral machine housing, such that the plane of the lateral machine housing and the chute bottom are arranged at an angle between 50° and 70 with respect to one another.

20. The slicer as claimed in claim 16, wherein the knife gap runs in the plane of the chute bottom and runs perpendicularly with respect to the longitudinal direction of the chute for the material to be sliced.

21. The slicer as claimed in claim 1, wherein the lever is connected to the shaft at a stationary pivot point, wherein the connection has a joint, such that the angle between the shaft and the lever can be changed during the movement of the lever from the removal position, in which the tiltable bread flap is located in the removal position, into the working position, in which the tiltable bread flap is located in the working position, such that the lever is always oriented with its longitudinal direction in a vertical plane during the movement, which plane runs parallel to the lateral machine housing.

22. The slicer as claimed in claim 1, wherein the lever is connected to the shaft at a stationary pivot point, wherein the connection has a joint, such that the angle between the shaft and the lever is changeable during the movement of the lever from the removal position, in which the tiltable bread flap is located in the removal position, into the working position, in which the tiltable bread flap is located in the working position, such that the lever is always oriented with its longitudinal direction in a vertical plane during the movement, which plane runs parallel to the lateral machine housing.

23. The slicer as claimed in claim 22, wherein the shaft has two flattened sides at the stationary pivot point of the joint, and the lever has a fork at the connection point to the shaft, such that the fork engages over the flattened sides of the shaft and a torque can be exerted on the shaft by the lever, wherein, for the connection between the shaft and the fork, a pin penetrates the shaft and the fork in a perpendicular orientation with respect to the flattened sides and forms a joint which brings about a connection which is rotatable in the longitudinal direction of the shaft between the fork and the shaft.

24. The slicer as claimed in claim 21, wherein a guide element is present on the machine housing, the guide element forming a guide for the lever, and the lever is oriented with its longitudinal direction in a vertical plane during the movement, the plane running parallel to the lateral machine housing.

25. The slicer as claimed in claim 24, wherein the guide element has the shape of a square tube, from which a guide rail is cut out, wherein the cutting angle of the guide rail corresponds to the angle by which the chute bottom is inclined with respect to the plane of the lateral machine housing, and the guide rail runs parallel to the plane of the lateral machine housing.

26. The slicer as claimed in claim 1,
wherein the slicer comprises a feed unit, and the feed plate is part of the feed unit,
wherein the feed unit comprises a gripper for gripping and holding a loaf of bread on the feed plate,
wherein the gripper comprises gripping prongs which are mounted rotatably on the feed unit, and the gripping prongs are substantially covered by the feed plate in the open state of the gripper, and wherein the gripping prongs project from the feed plate in the closed state of the gripper,
wherein the gripper is configured to move from the open state into the closed state by a gripper motor by way of a rotational movement of a gripper shaft,
wherein the gripping prongs are mechanically fixedly connected to the gripper shaft, and
wherein the gripper motor has a fixed position in relation to the machine housing and can be coupled to the feed unit via a coupling when the feed unit is located in an initial position.

27. The slicer as claimed in claim 1, wherein the slicer comprises a slice support which is movable in the longitudinal direction of the chute for the material to be sliced,
wherein the slice support has an undulating or serrated contour in the plane perpendicularly with respect to the longitudinal direction of the bread chute, and
wherein an end edge of the bread flap which is remote from the knife gap in the longitudinal direction of the chute for the material to be sliced is of undulating or serrated design.

28. The slicer as claimed in claim 27, wherein the elevations and depressions of the undulating or serrated contour of the slice support extend in their longitudinal direction perpendicularly with respect to the contact surface of the bread flap.
